(19) United States
(12) Patent Application Publication
(10) Pub. No.: US 2016/0371772 A1
(43) Pub. Date: Dec. 22, 2016

(54) Method for Facilitating Personal Loans

(71) Applicants: Cesar Augusto Zuluaga Rueda, Toronto (CA); Dario Monares Ortiz, Bogota (CO)

(72) Inventors: Cesar Augusto Zuluaga Rueda, Toronto (CA); Dario Monares Ortiz, Bogota (CO)

(21) Appl. No.: 15/186,298

(22) Filed: Jun. 17, 2016

Related U.S. Application Data
(60) Provisional application No. 62/180,989, filed on Jun. 17, 2015.

(51) Int. Cl. G06Q 40/02; G06Q 30/08

(52) U.S. Cl. CPC G06Q 40/025; G06Q 30/08

(57) ABSTRACT

A method for facilitating personal loans, wherein a borrower account can submit a loan bid, or loan request, that includes a loan amount and a loan duration. The loan bid is displayed as one of a plurality of loan bids, wherein a lender account can select the loan bid from a loans request page and make a loan offer; the loan offer including an interest rate. The borrower account can then decide to accept or deny the loan offer. The loan amount is restricted according to a plurality of tiers, wherein the borrower account is associated with a specific tier. Making on time or late payments, increases or decreases a tier score respectively; increasing the tier score past a tier advancement threshold advances the borrower account to a higher level tier, while decreasing the tier score past a tier downgrade threshold downgrades the borrower account to a lower level tier.

The current application claims a priority to the U.S. Provisional Patent application Ser. No. 62/180,989 filed on Jun. 17, 2015.

### FIELD OF THE INVENTION

The present invention relates generally to personal loans. More specifically, the present invention is a method for facilitating personal loans, wherein borrowers can make public loan requests and personal lenders can select requests and make loan offers.

### BACKGROUND OF THE INVENTION

Present day, it is not uncommon for individuals to encounter problems with securing loans when they have poor government credit ratings. Depending on how poor an individual's poor credit rating is, the individual may not be able to obtain a loan from many trustworthy banking institutions. Due to company rules and regulations, many banks are not able to offer loans to those with very low credit scores. In cases where a bank or institution will give a loan to an individual with a poor credit rating, the loan more likely than not will come with a very high interest rate to offset the risk that the lending company is taking. Such problems may limit the potential of individuals in terms of financial capability, especially when accepting a loan with a high interest rate, as it puts an even higher financial burden on the individual at a later date. As such users may have difficulty procuring loans from banks or other legitimate lenders, they oftentimes resort to illegal means of loan procurement, such as loan sharking.

Therefore it is an objective of the present invention to provide a method for facilitating loans between borrowers and lenders. The present invention allows a borrower to publicly request a loan and set the time period in which the borrower intends to repay the loan. Lenders can then view loans that are publicly posted by borrowers. A lender can inspect the profile page of a borrower to evaluate a loan payment history and risk factor, and determine whether or not they would like to loan money to the borrower. If the lender would like to loan money to the borrower, the lender makes a loan offer that includes an interest rate set by the lender. The borrower can then accept or deny the loan offer. Furthermore, the present invention limits the maximum amount of money the borrower can request by instituting a plurality of tiers. A maximum loan amount is associated with each tier, and the borrower can increase or decrease the tier level by making on time payments or late payments, respectively.

### BRIEF DESCRIPTION OF THE DRAWINGS

FIG. 1 is a diagram depicting the communications between the back-end system and the borrower account and the lender account.

FIG. 2 is a flowchart depicting the process for facilitating a loan between a borrower account and a lender account, and for managing a tier level of the borrower account.

FIG. 3 is a flowchart thereof, further depicting steps for activating the borrower account and the lender account.

FIG. 4 is a flowchart thereof, further depicting steps for publicly displaying the loan bid such that the lender can select the loan bid in order to place a loan offer.

FIG. 5 is a flowchart thereof, further depicting steps for managing the tier level with which the borrower account in associated.

FIG. 6 is a flowchart thereof, further depicting steps for increasing or decreasing the tier score of the borrower account in order to manage the tier level.

FIG. 7 is a flowchart thereof, further depicting steps for publicly displaying loan payment history and the risk factor of the borrower account on a profile page of the borrower account.

FIG. 8 is a flowchart thereof, further depicting steps for displaying investment tracking tools on a profile page of the lender account.

FIG. 9 is a flowchart depicting the process for activating accounts and engaging in transactions between borrower accounts and lender accounts.

FIG. 10 is a flowchart depicting the process for negotiating a loan between the borrower account and the lender account.

FIG. 11 is a flowchart depicting the process for adjusting the tier score and the tier level of the borrower account.

FIG. 12 is a diagram depicting the plurality of tiers and the maximum loan amount associated with each of the plurality of tiers.

### DETAIL DESCRIPTIONS OF THE INVENTION

All illustrations of the drawings are for the purpose of describing selected versions of the present invention and are not intended to limit the scope of the present invention.

The present invention is a method for facilitating personal loans, wherein borrowers can make public loan requests and personal lenders can select requests and make loan offers. A back-end network is provided to handle electronic communications, computations, and processes and allows end users to remotely access provided services. The back-end network can include any networking equipment required for digital storage and processing and for communication with the end users.

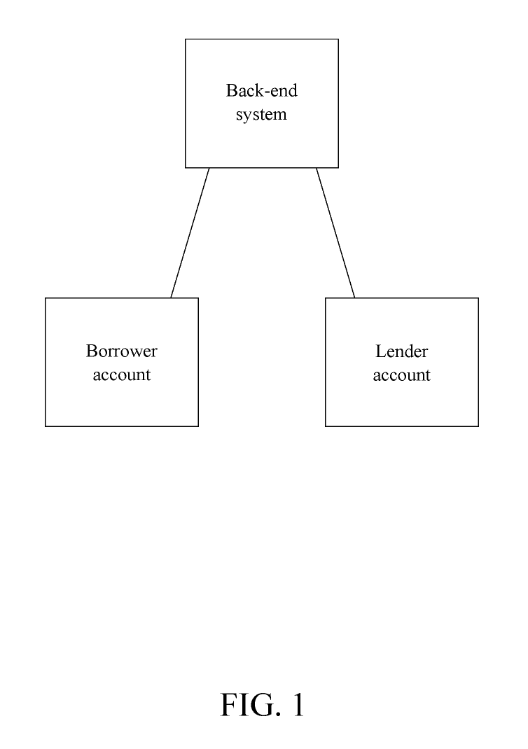

In reference to FIG. 1, the back-end network serves to connect a plurality of borrower accounts with a plurality of lender accounts; each of the plurality of borrower accounts and each of the plurality of lender accounts being associated with a single entity. Each of the plurality of borrower accounts can request to borrow an amount of money up to an established maximum limit; the established maximum limit varies for each individual and is based on the history of the individual. Loan requests are publicly displayed, wherein each of the plurality of lender accounts can choose to finance one or more of the plurality of borrower accounts.

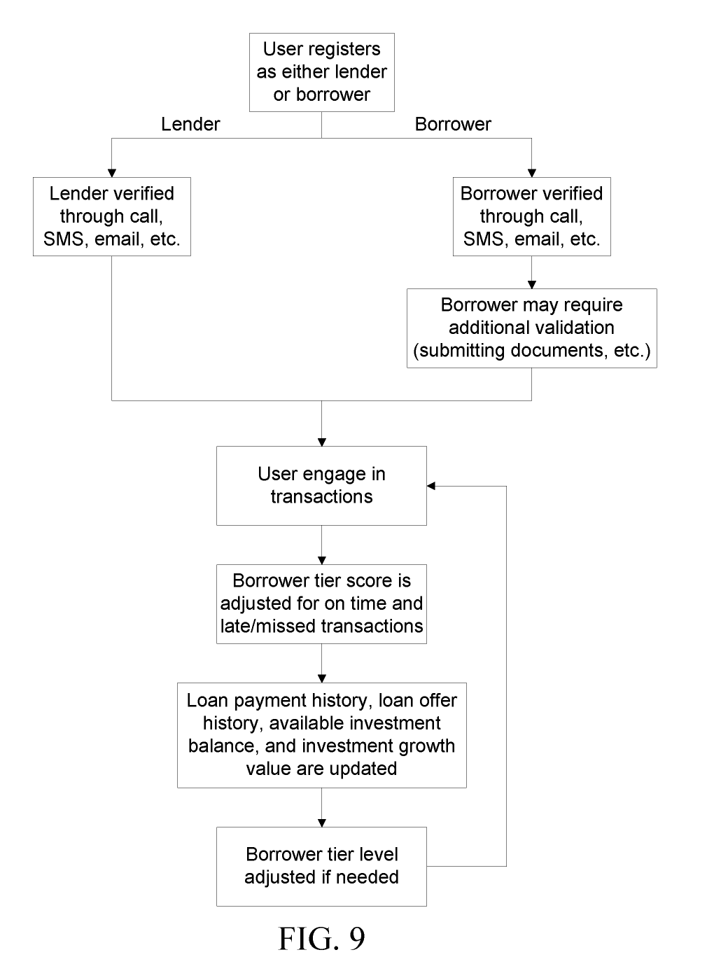

In reference to FIG. 9, in order to utilize the services hosted by the back-end system, an individual must first register either a borrower account or a lender account with the back-end system. To set up the lender account, the lender enters personal user information into a front-end (e.g. website, application) through a lender computing device (e.g. smartphone, laptop, etc.). The personal user information may include, but is not limited to, a name, a date of birth, an address, a phone number, and an email. It is also possible for some or all of the personal user information to be provided to the back-end system by utilizing a third party authorization platform such as OAuth. Once the personal user information for the lender account is received from the lender computing device by the back-end system, the personal user information is reviewed and validated.

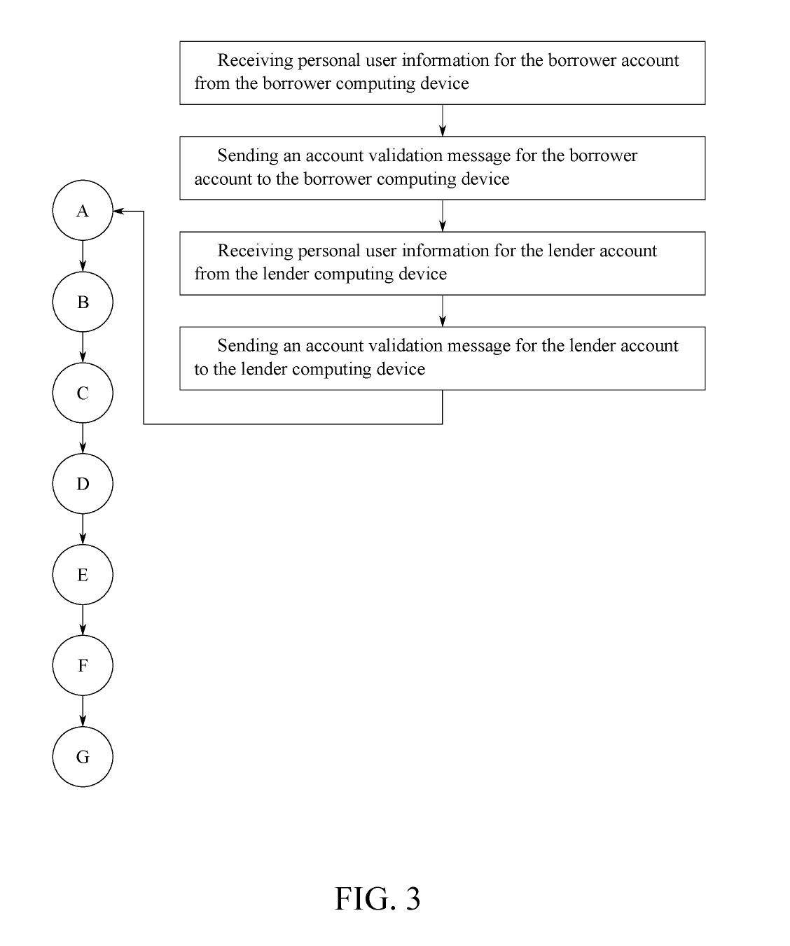

In the preferred embodiment of the present invention, the personal user information for the lender account is reviewed and validated manually by an administrative user. However, in other embodiments, automated processes may be installed to electronically review and validate the personal user information by the back-end system. In reference to FIG. 3, when the personal user information for the lender account is verified, an account validation message for the lender account is sent by the back-end system to the lender computing device. The lender account is then activated, allowing the lender to view and select loan offers.

In reference to FIG. 9, the account validation message can be sent via email, short messaging service (SMS), or any other electronic communication. In some embodiments, the lender may be required to respond to the account validation message in order to activate the lender account. One method for activating the lender account includes inserting a hypertext link into the account validation message, wherein the lender selects the hypertext link and is instructed to log in to the lender account. Another method for activating the lender account is by sending a response to the back-end system via SMS. Yet another method for activating the lender account is entering a personal identification number (PIN) number provided in the account validation message into the front-end.

Similar to the lender account, to set up the borrower account, an borrower enters personal user information into the front-end through a borrower computing device (e.g. smartphone, laptop, etc.). The personal user information for the borrower account may include, but is not limited to, a name, a date of birth, an address, a phone number, and an email. It is also possible for some or all of the personal user information for the borrower account to be provided to the back-end system by utilizing a third party authorization platform such as OAuth. Once the personal user information for the borrower account is received from the borrower computing device by the back-end system, the personal user information is reviewed and validated.

In the preferred embodiment of the present invention, the personal user information for the borrower account is reviewed and validated manually by an administrative user. However, in other embodiments, automated processes may be installed to electronically review and validate the personal user information by the back-end system. In reference to FIG. 3, when the personal user information for the borrower account is verified, an account validation message for the borrower account is sent by the back-end system to the borrower computing device. The borrower account is then activated, allowing the borrower to view and select loan offers.

In reference to FIG. 9, the account validation message for the borrower account can be sent via email, SMS, or any other electronic communication. In some embodiments, the borrower may be required to respond to the account validation message for the borrower account in order to activate the borrower account. One method for activating the borrower account includes inserting a hypertext link into the account validation message for the borrower account, wherein the borrower selects the hypertext link and is instructed to log in to the borrower account. Another method for activating the borrower account is by sending a response to the back-end system via SMS. Yet another method for activating the borrower account is entering a PIN number provided in the account validation message for the borrower account into the front-end.

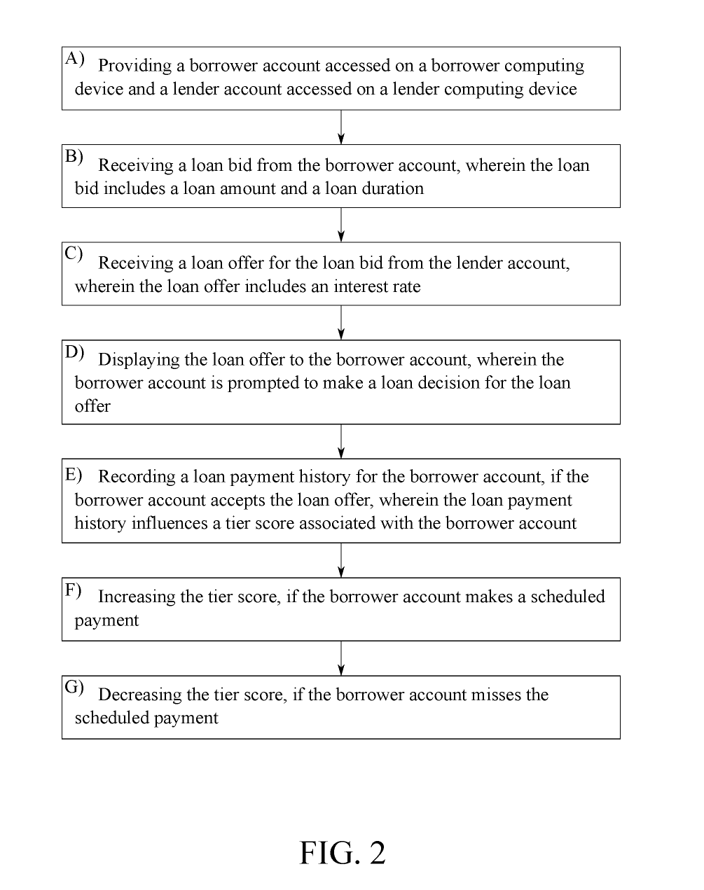

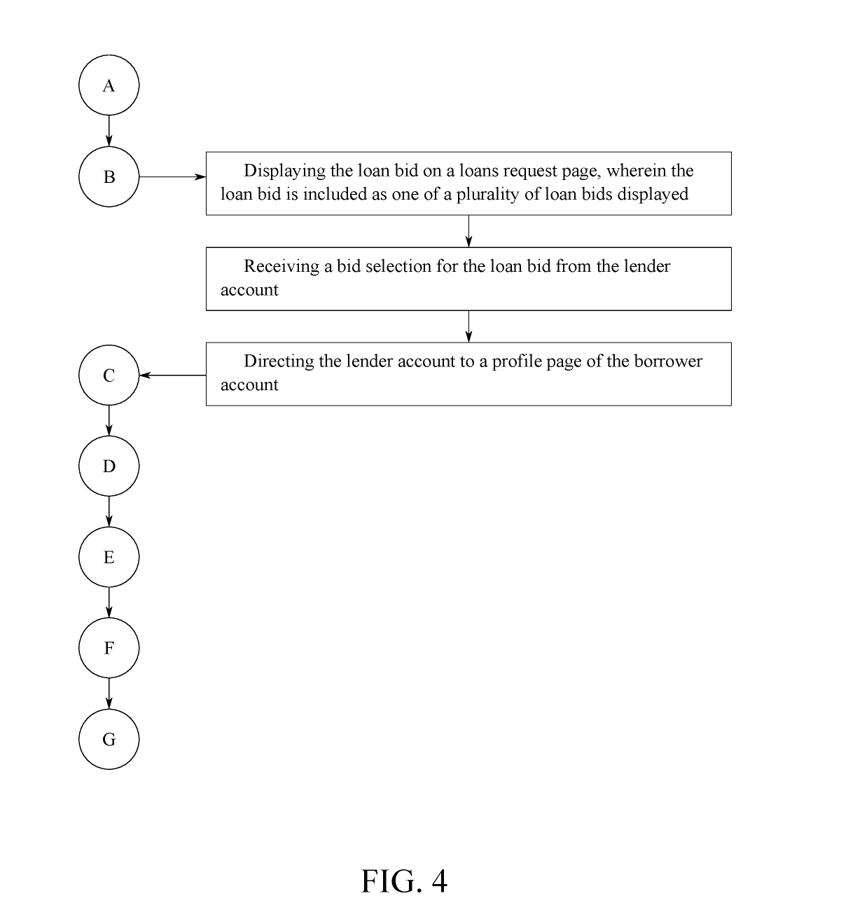

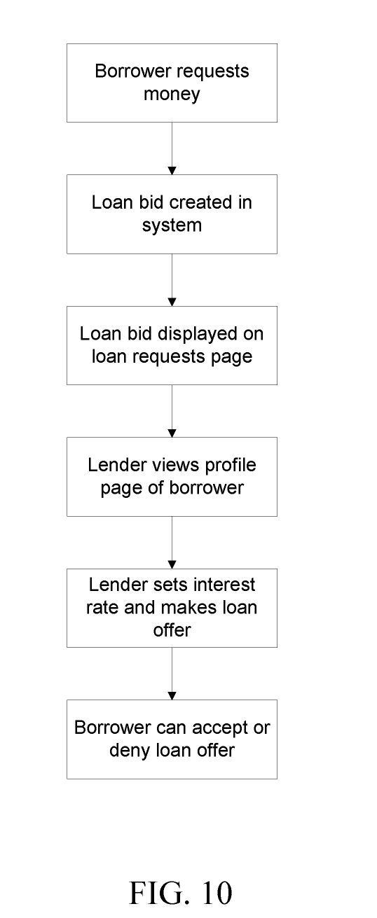

In reference to FIG. 2 and FIG. 10, once the borrower account is activated, the borrower can post a loan bid, or loan request, through the borrower account. The loan bid includes a loan amount and a loan duration; the loan amount being the sum of money requested by the borrower and the loan duration being the period of time in which the borrower intends to provide restitution to the lender. The loan duration may include one set payment deadline or multiple payment deadlines (e.g. weekly payment, bi-monthly payments, monthly payments, etc.). The back-end system receives the loan bid from the borrower account through the borrower computing device, wherein the back-end system displays the loan bid on a loans request page, as depicted in FIG. 4 and FIG. 10.

The loan request page displays a plurality of loan bids that are submitted by the plurality of borrower accounts. As such, the loan bid submitted by the borrower account is included as one of the plurality of loan bids displayed on the loans request page. In the preferred embodiment of the present invention, the loans request page is the main page displayed by the front-end, such that lenders can readily view the plurality of loan bids. Both the loan amount and the loan duration are displayed on the loan request page, allowing the lender to gauge interest in the loan bid. If the lender is interested in the loan bid, then the lender can select the loan bid in order to place a loan offer that is then reviewed by the borrower.

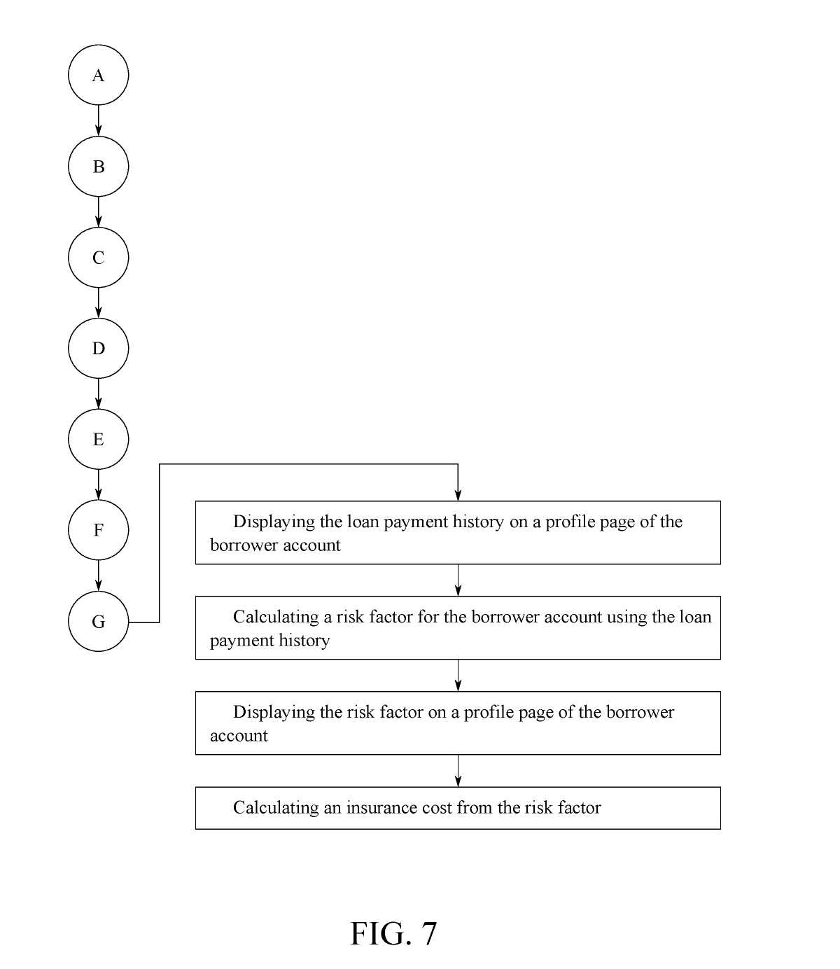

In reference to FIG. 4, the back-end system receives a bid selection for the loan bid from the lender account, wherein the back-end system directs the lender account to a profile page of the borrower account. In reference to FIG. 7, the back-end system displays, through the profile page, a loan payment history for the borrower account, a risk factor for the borrower account, and other pertinent information that can be utilized by the lender to determine whether or not to make the loan offer for the loan bid. The other pertinent information that is displayed may include, but is not limited to, a job title, a salary, and an education history.

The loan payment history provides a record of each payment made by the borrower for an acquired loan; indicating whether each payment was on time or late. Meanwhile, the risk factor is calculated by the back-end system using, at least in part, the loan payment history, wherein the risk factor provides a numerical or categorical representation of the borrower's creditworthiness. For example, the risk factor could be displayed as a number on a scale from 1 to 5, with a 1 being lowest risk and a 5 being highest risk. Ultimately, the risk factor provides a visual reference that can be quickly observed and interpreted by the lender in order to form a lending decision.

Using the information provided through the profile page of the borrower account, the lender can gauge the trustworthiness of the borrower and determine whether or not to make the loan offer. In reference to FIG. 2 and FIG. 10, if the lender trusts the borrower, then the lender can submit the loan offer through the lender account, wherein the loan offer includes an interest rate. The interest rate is determined by the lender and can be a fixed rate, a monthly rate, yearly rate, etc. Once submitted, the back-end system receives the loan offer and displays the loan offer to the borrower account. The borrower account may also receive additional loan offers from additional lender accounts.

In reference to FIG. 2 and FIG. 10, upon receiving the loan offer, the borrower account is prompted to make a loan decision for the loan offer. The loan decision is a yes or no response as to whether or not the borrower would like to accept the loan offer and the interest rate proposed by the lender. The borrower may postpone making the loan decision, in an effort to receive more loan offers, however, it may be possible in some embodiments for the lender to retract the loan offer after a period of time. If the loan decision is a no, then the loan offer is withdrawn from the borrower account. If the loan decision is a yes, then funds in the sum of the loan amount are transferred between accounts and the terms of the loan offer are initiated.

The funds are transferred from the lender account to the borrower account through an escrow account. Funds are first transferred from a lender spending account that is linked to the lender account into the escrow account. The amount of funds transferred from the lender spending account to the escrow account determines an available investment balance for the lender account, wherein the lender can make loan offers so long as the available investment balance is greater than the loan amount. When funds are transferred from the lender spending account to the escrow account, a value equal to the loan amount is subtracted from the available investment balance.

Upon accepting the loan offer, funds equal to the loan amount are transferred from the escrow account to a borrower spending account that is linked to the borrower account. The borrower can then withdraw the funds from the borrower spending account. In order to repay the loan amount, funds are transferred from the borrower spending account to the escrow account. The funds can then be withdrawn by the lender, wherein the funds are transferred from the escrow account to the lender spending account. The lender spending account and the borrower spending account can be any type of money transfer account. For example, the lender spending account and the borrower spending account can be a personal bank account, an electronic payment account, a prepaid card account, etc.

If the loan offer is accepted by the borrower, the lender is also able to purchase insurance on the loan. In reference to FIG. 7, the back-end system calculates an insurance cost from the risk factor of the borrower account, wherein the insurance cost corresponds to the level of risk. For example, the insurance cost is higher for a higher risk borrower and lower for a lower risk borrower. The insurance cost may be displayed on the profile page of the borrower account alongside the risk factor, or the insurance cost may be presented to the lender when the loan offer is accepted. If the lender chooses to purchase insurance on the loan, then a value equal to the insurance cost is subtracted from the available investment balance.

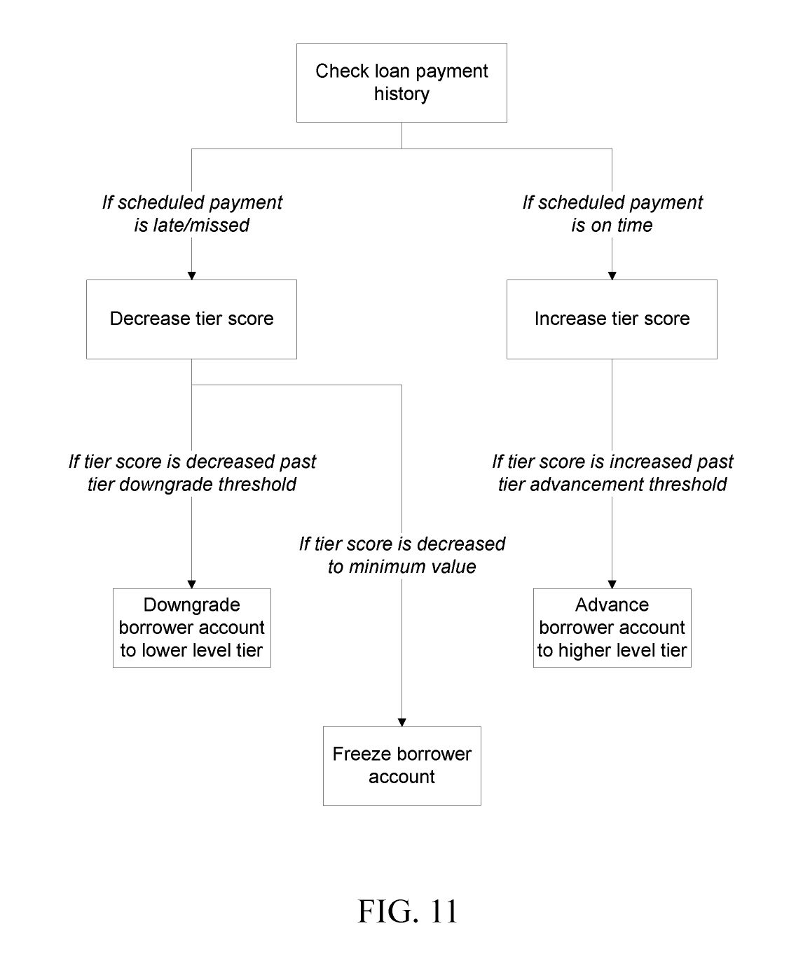

The amount of money that the borrower account can request as the loan amount is restricted according to a plurality of tiers, wherein the borrower account is associated with a specific tier from the plurality of tiers. The specific tier with which the borrower account is associated is determined by a tier score, wherein the tier score is influenced, at least in part, by the loan payment history that is recorded by the back-end system. In reference to FIG. 2 and FIG. 11, if the borrower account makes a scheduled payment on time, then the back-end system increases the tier score. Conversely, if the borrower misses the scheduled payment, then the back-end system decreases the tier score.

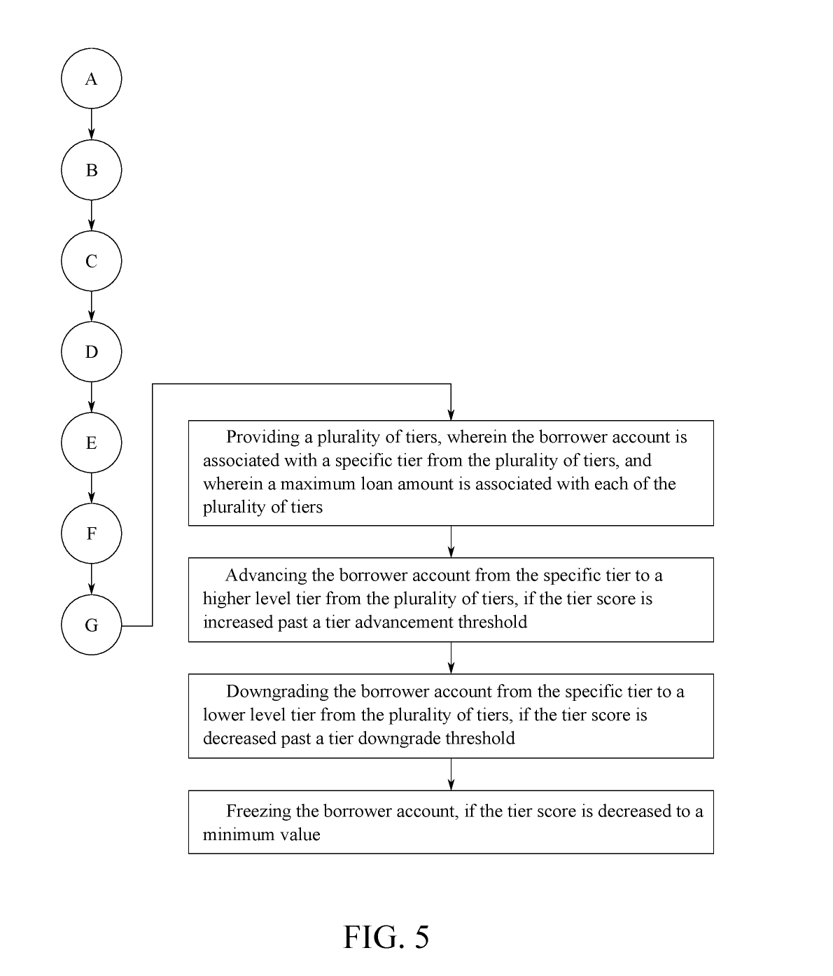

In reference to FIG. 5 and FIG. 11, depending on the loan payment history, it is possible for the borrower account to be advanced to a higher level tier from the plurality of tiers or downgraded to a lower level tier from the plurality of tiers. If the tier score is increased past a tier advancement threshold, then the back-end system advances the borrower account from the specific tier to the higher level tier. If the tier score is decreased past a tier downgraded threshold, then the back-end system downgrades the borrower account from the specific tier to the lower level tier. Furthermore, if the tier score is decreased to a minimum value, then the back-end system freezes the borrower account, wherein the borrower account is no longer authorized to place loan bids. Upon activating the borrower account, the tier score is started at an initial value.

In the preferred embodiment of the present invention, the initial value of the tier score is 100. The tier advancement threshold would then be set above 100, while the tier downgrade threshold and the minimum value would be set below 100. For example, the tier advancement threshold could be set at 200, while the tier downgrade threshold is set at 50 and the minimum value is set at 0. Each time the borrower makes an on time payment, the tier score is increased by a predetermined increment. Meanwhile, each time the borrower misses a payment, the tier score is decreased by a predetermined increment. If the tier score is increased over 200, then the borrower account is advanced to the higher level tier. If the tier score is decreased past 50, then the borrower account is downgraded to the lower level tier. If the tier score is decreased to 0, then the borrower account is frozen.

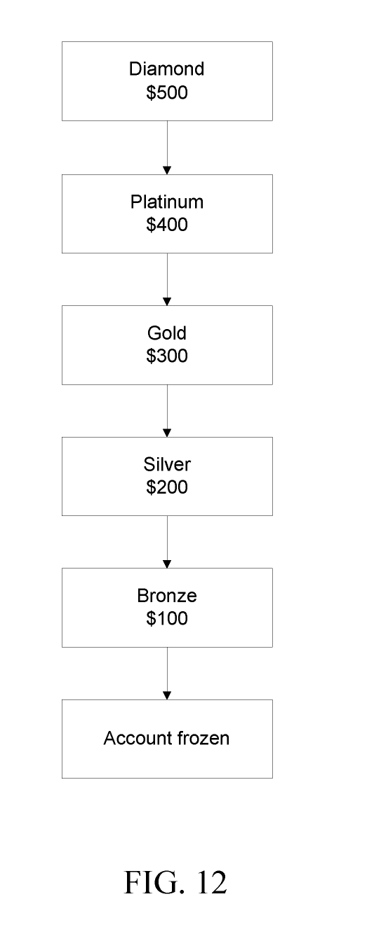

In reference to FIG. 12, a maximum loan amount is associated with each of the plurality of tiers, wherein the maximum loan amount is the upper limit on the loan amount designated by the borrower account; the maximum loan amount increasing as the tier level increases. In the preferred embodiment of the present invention there are five tiers as follows, listed from low to high: a bronze tier, a silver tier, a gold tier, a platinum tier, and a diamond tier. As the tiers advance from the bronze tier to the diamond tier, so does the maximum loan amount; the maximum loan amount for the bronze tier is $100; the maximum loan amount for the silver tier is $200; the maximum loan amount for the gold tier is $300; the maximum loan amount for the platinum tier is $400; and the maximum loan amount for the diamond tier is $500.

Similar to the tier score, upon activating the borrower account, the borrower account is started at an initial tier. In the preferred embodiment of the present invention, the initial tier is the silver tier. In reference to FIG. 11-12, if the borrower makes enough on time payments, then the borrower account is upgraded from the silver tier to the higher level tier; the higher level tier being the gold tier. If the borrower misses too many payments, then the borrower account is downgraded to the lower level tier; the lower level tier being the bronze tier. The specific tier is always the tier at which the borrower account is currently associated. As such, the higher level tier and the lower level tier are also linearly adjusted; the higher level tier and the lower level tier increasing one position as the specific tier increases one position, and decreasing one position as the specific tier decreases one position.

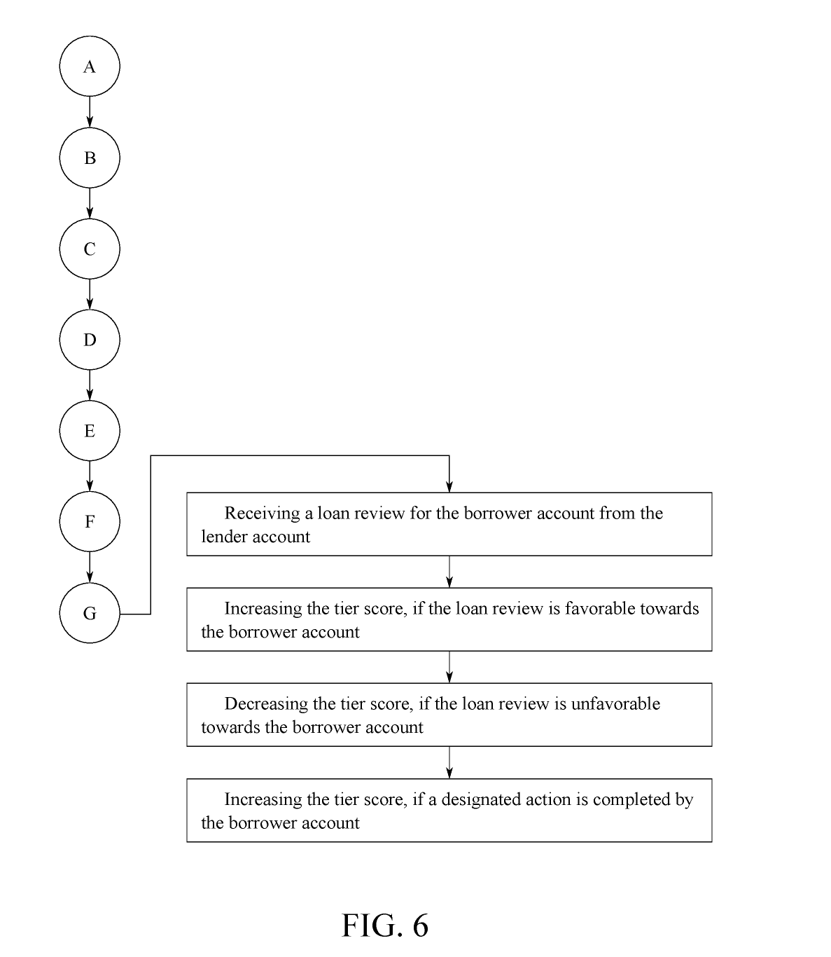

In reference to FIG. 6, it is also possible for the borrower account to increase the tier score by completing a designated action. The designated action can be any process that is selected by the administrators. For example, the designated action could be verifying the borrower account, or uploading a profile picture. The amount by which the tier score is increased may be dependent on the requirements of the designated action. More labor intensive or time consuming actions may be rewarded with a larger increase in the tier score. Once the designated action is completed by the borrower account, the back-end system increases the tier score accordingly.

In further reference to FIG. 6, in other embodiments, it is possible for the tier score to be affected by a loan review for the borrower account that is submitted by the lender account. The loan review could be provided as a follow-up to the loan transaction between the borrower and the lender, allowing the lender to express any positives or negatives in dealing with the borrower throughout the process. The back-end system receives and reviews the loan review, and then adjusts the tier score of the borrower account accordingly. If the loan review is favorable towards the borrower account, expressing a positive experience by the lender, then the tier score is increased. If the loan review is unfavorable towards the borrower account, expressing a negative experience by the lender, then the tier score is decreased.

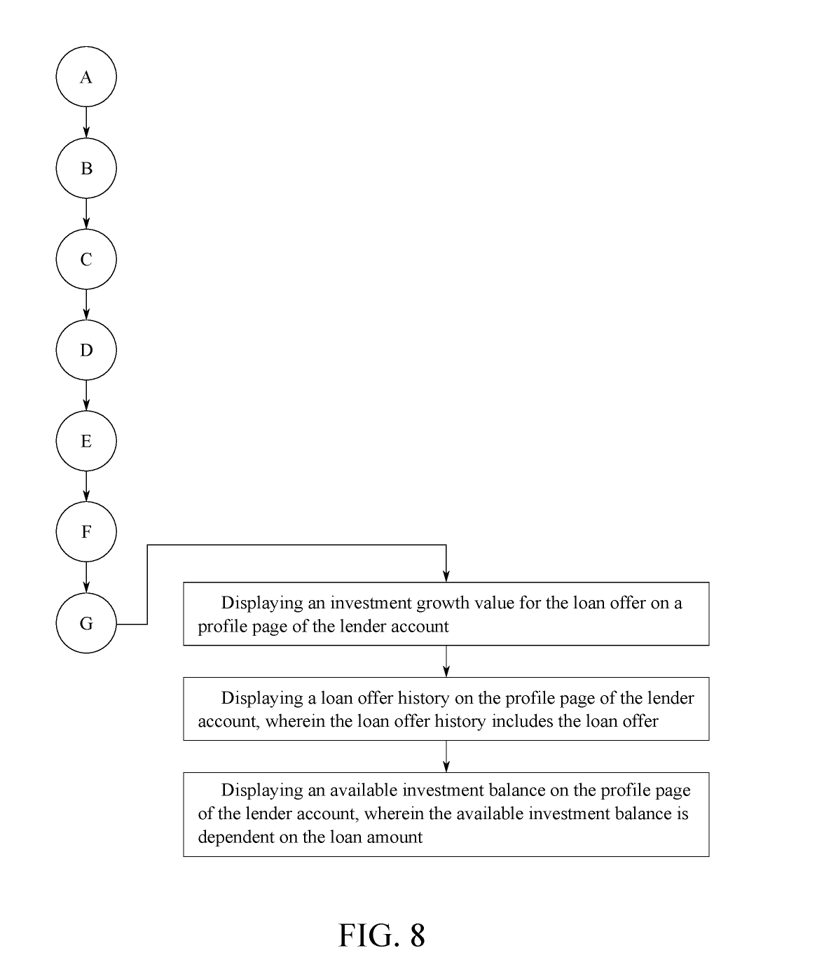

In reference to FIG. 8, in order to keep track of all active and past loans, a loan offer history is displayed on a profile page of the lender account. The loan offer history displays the loan amount for the loan offer and whether or not the loan has been paid off, either partially or in full. The loan offer history provides the lender with a complete record of all transactions, such that the lender can easily manage and track investments. In addition to the loan offer history, an investment growth value is displayed on the profile page of the lender account. The investment growth value can be used to depict the growth of a single investment over a period of time, the overall growth of every investment the lender has made, or the overall growth of a number of investments over a defined period of time. The investment growth value can be depicted in any desirable chart or graph as an overall percentage or percentage over time. Furthermore, the profile page of the lender account displays the available investment balance, such that the lender can keep track of available funds for future investments.

Although the invention has been explained in relation to its preferred embodiment, it is to be understood that many other possible modifications and variations can be made without departing from the spirit and scope of the invention as hereinafter claimed.

What is claimed is:

1. A method for facilitating personal loans by executing computer-executable instructions stored on a non-transitory computer-readable medium, the method comprises the steps of:
providing a borrower account accessed on a borrower computing device and a lender account accessed on a lender computing device;
receiving a loan bid from the borrower account, wherein the loan bid includes a loan amount and a loan duration;
receiving a loan offer for the loan bid from the lender account, wherein the loan offer includes an interest rate;
displaying the loan offer to the borrower account, wherein the borrower account is prompted to make a loan decision for the loan offer;
recording a loan payment history for the borrower account, if the borrower account accepts the loan offer, wherein the loan payment history influences a tier score associated with the borrower account;
increasing the tier score, if the borrower account makes a scheduled payment; and
decreasing the tier score, if the borrower account misses the scheduled payment.

2. The method for facilitating personal loans by executing computer-executable instructions stored on a non-transitory computer-readable medium, the method as claimed in claim 1 further comprises the step of:
displaying the loan bid on a loans request page, wherein the loan bid is included as one of a plurality of loan bids displayed.

3. The method for facilitating personal loans by executing computer-executable instructions stored on a non-transitory computer-readable medium, the method as claimed in claim 2 further comprises the steps of:
receiving a bid selection for the loan bid from the lender account; and
directing the lender account to a profile page of the borrower account.

4. The method for facilitating personal loans by executing computer-executable instructions stored on a non-transitory computer-readable medium, the method as claimed in claim 1 further comprises the steps of:
providing a plurality of tiers, wherein the borrower account is associated with a specific tier from the plurality of tiers;
advancing the borrower account from the specific tier to a higher level tier from the plurality of tiers, if the tier score is increased past a tier advancement threshold; and
downgrading the borrower account from the specific tier to a lower level tier from the plurality of tiers, if the tier score is decreased past a tier downgrade threshold.

5. The method for facilitating personal loans by executing computer-executable instructions stored on a non-transitory computer-readable medium, the method as claimed in claim 4, wherein a maximum loan amount is associated with each of the plurality of tiers.

6. The method for facilitating personal loans by executing computer-executable instructions stored on a non-transitory computer-readable medium, the method as claimed in claim 1 further comprises the step of:
freezing the borrower account, if the tier score is decreased to a minimum value.

7. The method for facilitating personal loans by executing computer-executable instructions stored on a non-transitory computer-readable medium, the method as claimed in claim 1 further comprises the steps of:
receiving a loan review for the borrower account from the lender account;
increasing the tier score, if the loan review is favorable towards the borrower account; and
decreasing the tier score, if the loan review is unfavorable towards the borrower account.

8. The method for facilitating personal loans by executing computer-executable instructions stored on a non-transitory computer-readable medium, the method as claimed in claim 1 further comprises the step of:
increasing the tier score, if a designated action is completed by the borrower account.

9. The method for facilitating personal loans by executing computer-executable instructions stored on a non-transitory computer-readable medium, the method as claimed in claim 1 further comprises the steps of:
calculating a risk factor for the borrower account using the loan payment history; and
displaying the risk factor on a profile page of the borrower account.

10. The method for facilitating personal loans by executing computer-executable instructions stored on a non-transitory computer-readable medium, the method as claimed in claim 9 further comprises the step of:
calculating an insurance cost from the risk factor.

11. The method for facilitating personal loans by executing computer-executable instructions stored on a non-transitory computer-readable medium, the method as claimed in claim 1 further comprises the step of:
displaying the loan payment history on a profile page of the borrower account.

12. The method for facilitating personal loans by executing computer-executable instructions stored on a non-transitory computer-readable medium, the method as claimed in claim 1 further comprises the step of:
receiving personal user information for the borrower account from the borrower computing device; and
sending an account validation message for the borrower account to the borrower computing device.

13. The method for facilitating personal loans by executing computer-executable instructions stored on a non-transitory computer-readable medium, the method as claimed in claim 1 further comprises the step of:
receiving personal user information for the lender account from the lender computing device; and
sending an account validation message for the lender account to the lender computing device.

14. The method for facilitating personal loans by executing computer-executable instructions stored on a non-transitory computer-readable medium, the method as claimed in claim 1 further comprises the step of:
displaying an investment growth value for the loan offer on a profile page of the lender account.

15. The method for facilitating personal loans by executing computer-executable instructions stored on a non-transitory computer-readable medium, the method as claimed in claim 14 further comprises the step of:
displaying a loan offer history on the profile page of the lender account, wherein the loan offer history includes the loan offer.

16. The method for facilitating personal loans by executing computer-executable instructions stored on a non-transitory computer-readable medium, the method as claimed in claim 1 further comprises the step of:
displaying an available investment balance on a profile page of the lender account, wherein the available investment balance is dependent on the loan amount.
